(19) United States
(12) Patent Application Publication
(10) Pub. No.: US 2026/0014932 A1
(43) Pub. Date: Jan. 15, 2026

(54) NON-LINE-OF-SIGHT IMMINENT CRASH WARNING USING REFLECTIVE HEAD-UP DISPLAYS

(71) Applicant: GM Global Technology Operations LLC, Detroit, MI (US)

(72) Inventors: Kai-Han Chang, Madison Heights, MI (US); Joseph F. Szczerba, Grand Blanc, MI (US); Thomas A. Seder, Fraser, MI (US); Guy N. Kennerly, Southfield, MI (US)

(73) Assignee: GM Global Technology Operations LLC, Detroit, MI (US)

(21) Appl. No.: 18/768,848

(22) Filed: Jul. 10, 2024

(51) Int. Cl. B60Q 9/00; B60K 35/23; G06T 7/20; G06T 11/00; G08G 1/16

(52) U.S. Cl. CPC B60Q 9/008; G06T 7/20; G06T 11/00; B60K 35/23; B60K 2360/177; B60K 2360/178; B60K 2360/21; G06T 2207/10028; G06T 2207/10044; G06T 2207/30241; G06T 2207/30261; G08G 1/166

(57) ABSTRACT

A system and method of non-line-of-sight imminent crash warning using reflective head-up displays includes receiving sensor data detected by a sensor system of a vehicle and indicating an object moving toward the vehicle, and determining, based on the sensor data, that the object is located outside of a line of sight of a driver of the vehicle. The system and method also include determining that a trajectory of the object and a trajectory of the vehicle will cross, and displaying, via head-up displays, a graphical alert alerting the driver of the vehicle to the object that is located outside of the line of sight of the driver.

### INTRODUCTION

The information provided in this section is for the purpose of generally presenting the context of the disclosure. Work of the presently named inventors, to the extent it is described in this section, as well as aspects of the description that may not otherwise qualify as prior art at the time of filing, are neither expressly nor impliedly admitted as prior art against the present disclosure.

The present disclosure relates generally to a system and method of non-light of sight imminent crash warnings using reflective head-up displays. Generally, vehicle collisions may be classified into one or more types. For example, types of collisions may include single-vehicle, backing, head-on, rear-end, sideswipe, and/or angle, and others. While current vehicle sensor systems are particularly adept at identifying and notifying a driver about potential impacts within a driver's line-of-sight (e.g., the driver's view while facing forward) using current displays, a large percentage (e.g., 27%) of all vehicle collisions annually are associated with non-line-of-sight collision types, such as sideswipe and angle.

Moreover, for safety reasons, it is critical that any visual alerting methods do not distract the driver's focus from the roadway in front of the vehicle. As such, providing non-line-of-sight alerts using the pillar-to-pillar display capabilities may integrate safety alerts with the driver's view with the roadway while limiting distractions. Further, providing advance notice to a driver of the urgency and direction of an imminent collision that is otherwise outside of the driver's line-of-sight gives the driver time to take corrective action to avoid the imminent collision.

### SUMMARY

One aspect of the disclosure provides a computer-implemented method for non-line-of-sight imminent crash warning using reflective head-up displays that when executed on data processing hardware causes the data processing hardware to perform operations that include receiving sensor data detected by a sensor system of a vehicle, the sensor data indicating an object moving toward the vehicle, and determining, based on the sensor data, that the object is located outside of a line of sight of a driver of the vehicle. The operations also include determining that a trajectory of the object and a trajectory of the vehicle will cross, and displaying, via head-up displays, a graphical alert alerting the driver of the vehicle to the object that is located outside of the line of sight of the driver.

Implementations of the disclosure may include one or more of the following optional features. In some implementations, the head-up displays include an augmented reality head-up display and a blackout head-up display. In these implementations, displaying, via the head-up displays, a graphical alert alerting the driver of the vehicle to the object that is located outside of the line of sight of the driver may further include generating an augmented reality image overlay, generating a virtual image, and projecting the augmented reality image overlay and the virtual image on a windshield of the vehicle simultaneously. Projecting the augmented reality image overlay and the virtual image on the windshield of the vehicle may further include projecting the augmented reality image overlay on a clear portion of the windshield and projecting the virtual image on a blackout portion of the windshield. Additionally or alternatively, the augmented reality image overlay is different from the virtual image.

In some examples, the sensor system includes one or more of cameras, radio detection and ranging (RADAR), and light detection and ranging (LIDAR). In some implementations, determining that a trajectory of the object and a trajectory of the vehicle will cross includes receiving vehicle data, calculating, based on the sensor data, the trajectory of the object, calculating, based on the vehicle data, the trajectory of the vehicle, and determining whether the trajectory of the object and the trajectory of the vehicle cross. In these implementations, the operations may further include determining, based on the trajectory of the object and the trajectory of the vehicle, a time to collision between the object and the vehicle. Here, the operations may further include generating the graphical alert based on the time to collision between the object and the vehicle. In some examples, displaying, via the head-up displays, the graphical alert alerting the driver of the vehicle to the object that is located outside of the line of sight of the driver includes displaying the graphical alert on a windshield of the vehicle to indicate a direction of the object.

Another aspect of the disclosure provides a system for non-line-of-sight imminent crash warning using reflective head-up displays that includes data processing hardware and memory hardware in communication with the data processing hardware. The memory hardware stores instructions that when executed by the data processing hardware cause the data processing hardware to perform operations that include receiving sensor data detected by a sensor system of a vehicle, the sensor data indicating an object moving toward the vehicle, and determining, based on the sensor data, that the object is located outside of a line of sight of a driver of the vehicle. The operations also include determining that a trajectory of the object and a trajectory of the vehicle will cross, and displaying, via head-up displays, a graphical alert alerting the driver of the vehicle to the object that is located outside of the line of sight of the driver.

This aspect may include one or more of the following optional features. In some implementations, the head-up displays include an augmented reality head-up display and a blackout head-up display. In these implementations, displaying, via the head-up displays, a graphical alert alerting the driver of the vehicle to the object that is located outside of the line of sight of the driver may further include generating an augmented reality image overlay, generating a virtual image, and projecting the augmented reality image overlay and the virtual image on a windshield of the vehicle simultaneously. Projecting the augmented reality image overlay and the virtual image on the windshield of the vehicle may further include projecting the augmented reality image overlay on a clear portion of the windshield and projecting the virtual image on a blackout portion of the windshield. Additionally or alternatively, the augmented reality image overlay is different from the virtual image.

In some examples, the sensor system includes one or more of cameras, radio detection and ranging (RADAR), and light detection and ranging (LIDAR). In some implementations, determining that a trajectory of the object and a trajectory of the vehicle will cross includes receiving vehicle data, calculating, based on the sensor data, the trajectory of the object, calculating, based on the vehicle data, the trajectory of the vehicle, and determining whether the trajectory of the object and the trajectory of the vehicle cross. In these implementations, the operations may further include determining, based on the trajectory of the object and the trajectory of the vehicle, a time to collision between the object and the vehicle. Here, the operations may further include generating the graphical alert based on the time to collision between the object and the vehicle. In some examples, displaying, via the head-up displays, the graphical alert alerting the driver of the vehicle to the object that is located outside of the line of sight of the driver includes displaying the graphical alert on a windshield of the vehicle to indicate a direction of the object.

The details of one or more implementations of the disclosure are set forth in the accompanying drawings and the description below. Other aspects, features, and advantages will be apparent from the description and drawings, and from the claims.

### BRIEF DESCRIPTION OF THE DRAWINGS

The drawings described herein are for illustrative purposes only of selected configurations and are not intended to limit the scope of the present disclosure.

FIG. 1 is a schematic view of an example system using a non-line-of-sight imminent crash warning using reflective head-up displays.

FIG. 2 is a schematic view of example components of the system of FIG. 1.

FIG. 3 is a crash model flowchart for the system of FIG. 1.

FIG. 4 is a schematic view of head-up displays of the system of FIG. 1.

FIG. 5 is a schematic view of head-up displays of the system of FIG. 1.

FIG. 6 is a flowchart of an example arrangement of operations for a method of a non-line-of-sight imminent crash warning using reflective head-up displays.

Corresponding reference numerals indicate corresponding parts throughout the drawings.

### DETAILED DESCRIPTION

Example configurations will now be described more fully with reference to the accompanying drawings. Example configurations are provided so that this disclosure will be thorough, and will fully convey the scope of the disclosure to those of ordinary skill in the art. Specific details are set forth such as examples of specific components, devices, and methods, to provide a thorough understanding of configurations of the present disclosure. It will be apparent to those of ordinary skill in the art that specific details need not be employed, that example configurations may be embodied in many different forms, and that the specific details and the example configurations should not be construed to limit the scope of the disclosure.

The terminology used herein is for the purpose of describing particular exemplary configurations only and is not intended to be limiting. As used herein, the singular articles “a,” “an,” and “the” may be intended to include the plural forms as well, unless the context clearly indicates otherwise. The terms “comprises,” “comprising,” “including,” and “having,” are inclusive and therefore specify the presence of features, steps, operations, elements, and/or components, but do not preclude the presence or addition of one or more other features, steps, operations, elements, components, and/or groups thereof. The method steps, processes, and operations described herein are not to be construed as necessarily requiring their performance in the particular order discussed or illustrated, unless specifically identified as an order of performance. Additional or alternative steps may be employed.

When an element or layer is referred to as being “on,” “engaged to,” “connected to,” “attached to,” or “coupled to” another element or layer, it may be directly on, engaged, connected, attached, or coupled to the other element or layer, or intervening elements or layers may be present. In contrast, when an element is referred to as being “directly on,” “directly engaged to,” “directly connected to,” “directly attached to,” or “directly coupled to” another element or layer, there may be no intervening elements or layers present. Other words used to describe the relationship between elements should be interpreted in a like fashion (e.g., “between” versus “directly between,” “adjacent” versus “directly adjacent,” etc.). As used herein, the term “and/or” includes any and all combinations of one or more of the associated listed items.

The terms “first,” “second,” “third,” etc. may be used herein to describe various elements, components, regions, layers and/or sections. These elements, components, regions, layers and/or sections should not be limited by these terms. These terms may be only used to distinguish one element, component, region, layer or section from another region, layer or section. Terms such as “first,” “second,” and other numerical terms do not imply a sequence or order unless clearly indicated by the context. Thus, a first element, component, region, layer or section discussed below could be termed a second element, component, region, layer or section without departing from the teachings of the example configurations.

In this application, including the definitions below, the term “module” may be replaced with the term “circuit.” The term “module” may refer to, be part of, or include an Application Specific Integrated Circuit (ASIC); a digital, analog, or mixed analog/digital discrete circuit; a digital, analog, or mixed analog/digital integrated circuit; a combinational logic circuit; a field programmable gate array (FPGA); a processor (shared, dedicated, or group) that executes code; memory (shared, dedicated, or group) that stores code executed by a processor; other suitable hardware components that provide the described functionality; or a combination of some or all of the above, such as in a system-on-chip.

The term “code,” as used above, may include software, firmware, and/or microcode, and may refer to programs, routines, functions, classes, and/or objects. The term “shared processor” encompasses a single processor that executes some or all code from multiple modules. The term “group processor” encompasses a processor that, in combination with additional processors, executes some or all code from one or more modules. The term “shared memory” encompasses a single memory that stores some or all code from multiple modules. The term “group memory” encompasses a memory that, in combination with additional memories, stores some or all code from one or more modules. The term “memory” may be a subset of the term “computer-readable medium.” The term “computer-readable medium” does not encompass transitory electrical and electromagnetic signals propagating through a medium, and may therefore be considered tangible and non-transitory memory. Non-limiting examples of a non-transitory memory include a tangible computer readable medium including a nonvolatile memory, magnetic storage, and optical storage.

The apparatuses and methods described in this application may be partially or fully implemented by one or more computer programs executed by one or more processors. The computer programs include processor-executable instructions that are stored on at least one non-transitory tangible computer readable medium. The computer programs may also include and/or rely on stored data.

A software application (i.e., a software resource) may refer to computer software that causes a computing device to perform a task. In some examples, a software application may be referred to as an “application,” an “app,” or a “program.” Example applications include, but are not limited to, system diagnostic applications, system management applications, system maintenance applications, word processing applications, spreadsheet applications, messaging applications, media streaming applications, social networking applications, and gaming applications.

The non-transitory memory may be physical devices used to store programs (e.g., sequences of instructions) or data (e.g., program state information) on a temporary or permanent basis for use by a computing device. The non-transitory memory may be volatile and/or non-volatile addressable semiconductor memory. Examples of non-volatile memory include, but are not limited to, flash memory and read-only memory (ROM)/programmable read-only memory (PROM)/erasable programmable read-only memory (EPROM)/electronically erasable programmable read-only memory (EEPROM) (e.g., typically used for firmware, such as boot programs). Examples of volatile memory include, but are not limited to, random access memory (RAM), dynamic random access memory (DRAM), static random access memory (SRAM), phase change memory (PCM) as well as disks or tapes.

These computer programs (also known as programs, software, software applications or code) include machine instructions for a programmable processor, and can be implemented in a high-level procedural and/or object-oriented programming language, and/or in assembly/machine language. As used herein, the terms “machine-readable medium” and “computer-readable medium” refer to any computer program product, non-transitory computer readable medium, apparatus and/or device (e.g., magnetic discs, optical disks, memory, Programmable Logic Devices (PLDs)) used to provide machine instructions and/or data to a programmable processor, including a machine-readable medium that receives machine instructions as a machine-readable signal. The term “machine-readable signal” refers to any signal used to provide machine instructions and/or data to a programmable processor.

Various implementations of the systems and techniques described herein can be realized in digital electronic and/or optical circuitry, integrated circuitry, specially designed ASICS (application specific integrated circuits), computer hardware, firmware, software, and/or combinations thereof. These various implementations can include implementation in one or more computer programs that are executable and/or interpretable on a programmable system including at least one programmable processor, which may be special or general purpose, coupled to receive data and instructions from, and to transmit data and instructions to, a storage system, at least one input device, and at least one output device.

The processes and logic flows described in this specification can be performed by one or more programmable processors, also referred to as data processing hardware, executing one or more computer programs to perform functions by operating on input data and generating output. The processes and logic flows can also be performed by special purpose logic circuitry, e.g., an FPGA (field programmable gate array) or an ASIC (application specific integrated circuit). Processors suitable for the execution of a computer program include, by way of example, both general and special purpose microprocessors, and any one or more processors of any kind of digital computer. Generally, a processor will receive instructions and data from a read only memory or a random access memory or both. The essential elements of a computer are a processor for performing instructions and one or more memory devices for storing instructions and data. Generally, a computer will also include, or be operatively coupled to receive data from or transfer data to, or both, one or more mass storage devices for storing data, e.g., magnetic, magneto optical disks, or optical disks. However, a computer need not have such devices. Computer readable media suitable for storing computer program instructions and data include all forms of non-volatile memory, media and memory devices, including by way of example semiconductor memory devices, e.g., EPROM, EEPROM, and flash memory devices; magnetic disks, e.g., internal hard disks or removable disks; magneto optical disks; and CD ROM and DVD-ROM disks. The processor and the memory can be supplemented by, or incorporated in, special purpose logic circuitry.

To provide for interaction with a user, one or more aspects of the disclosure can be implemented on a computer having a display device, e.g., a CRT (cathode ray tube), LCD (liquid crystal display) monitor, or touch screen for displaying information to the user and optionally a keyboard and a pointing device, e.g., a mouse or a trackball, by which the user can provide input to the computer. Other kinds of devices can be used to provide interaction with a user as well; for example, feedback provided to the user can be any form of sensory feedback, e.g., visual feedback, auditory feedback, or tactile feedback; and input from the user can be received in any form, including acoustic, speech, or tactile input. In addition, a computer can interact with a user by sending documents to and receiving documents from a device that is used by the user; for example, by sending web pages to a web browser on a user's client device in response to requests received from the web browser.

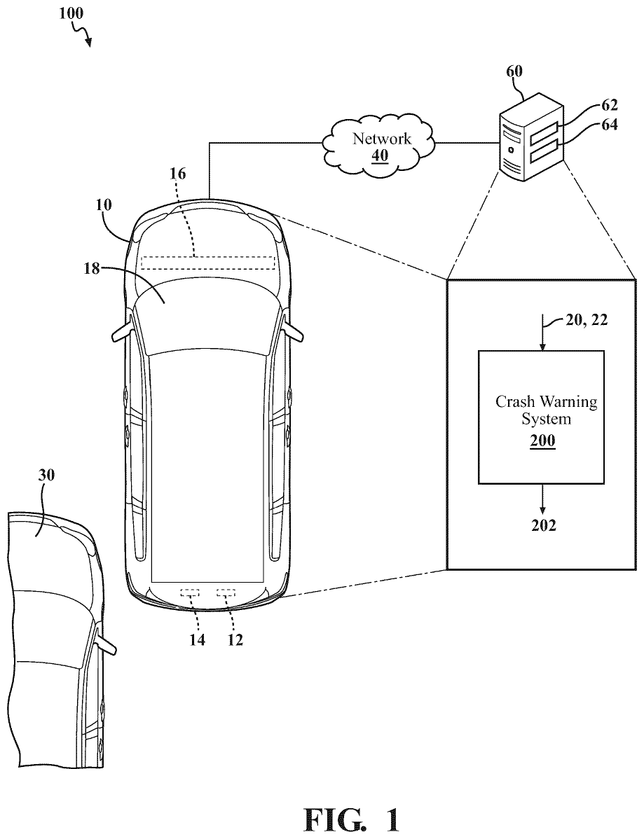

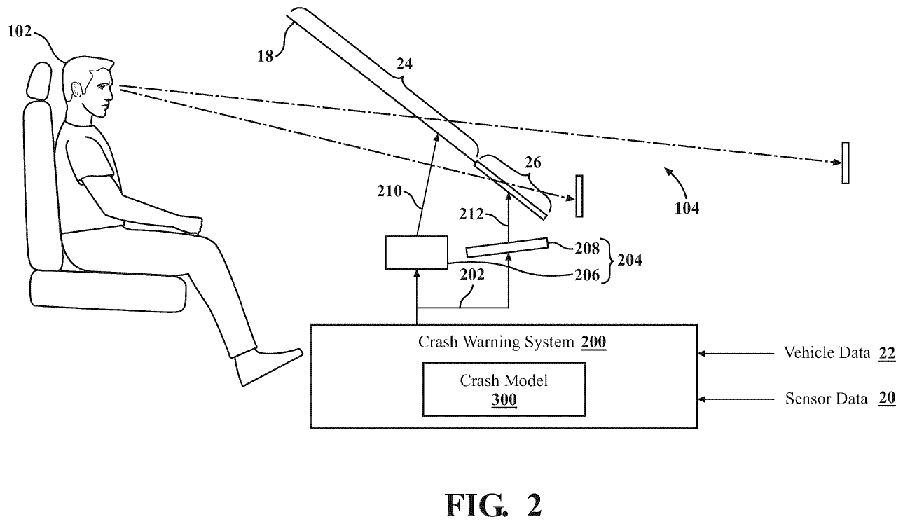

Referring to FIG. 1, in some implementations, a system 100 includes a vehicle 10 and/or a remote system 60 in communication with the vehicle 10 via a network 40. The vehicle 10 and/or the remote system 60 execute a non-line-of-site imminent crash warning system 200 (also referred to as a crash warning system 200) (FIG. 2). Briefly, and as described in further detail below, the crash warning system 200 is configured to receive sensor data 20 indicating that an object 30 is moving toward the vehicle 10, and, when the object 30 is located outside of a line of sight 104 of a driver 102 of the vehicle 10, displaying, via head-up displays 204, a graphical alert 202 alerting the driver 102 to the object 30. Notably, by alerting the driver 102 to the object 30 that is outside of the line of sight 104 of the driver 102, the driver 102 is given time to take corrective action to avoid imminent crash hazards that would otherwise not be visible to the driver 102. For example, imminent crash hazards that would otherwise not be visible to the driver may include an intersection crash due to another driver running a red light, or a sideswipe when another driver passes the vehicle 10.

As used herein, an object 30 that is located outside of the line of sight 104 of the driver 102 may generally refer to the positioning of the object 30 with respect to the vehicle 10 in real time, such that a vehicle occupant (e.g., the driver 102) cannot perceive the object 30 when the vehicle occupant is facing toward the front of the vehicle 10. Perception of the object 30 may be based, at least in part, on where the vehicle occupant is sitting inside the vehicle 10, and includes areas outside the vehicle 10 that are not naturally observable when the vehicle occupant's head is facing toward the front of the vehicle 10. These areas may also include areas outside of the vehicle 10 that are not naturally observable when the vehicle occupant's head turns from the neck to the right and to the left. An example of the line of sight 104 of the driver 102 is shown in FIG. 2, where the dotted arrows bound the line of sight 104, and where objects 30 located within the line of sight 104 are perceivable by the driver 102 when the driver 102 is facing toward the front of the vehicle 10. In some implementations, the line of sight 104 is a conical area in the direction of motion of the vehicle 10 ahead of the vehicle with a 120-degree field of view. The line of sight 104 may further extend roughly 800 meters in distance from the driver 102. In other implementations, the line of sight 104 is dynamic based on the geographic region and weather in which the vehicle 10 is driving.

In the examples shown, the crash warning system 200 is implemented within a vehicle 10. However, the crash warning system 200 can be implemented on other computing devices (e.g., computing devices in communication with the vehicle 10), such as, without limitation, a smart phone, tablet, smart display, desktop/laptop, smart watch, smart appliance, or smart glasses/headset. The vehicle 10 includes data processing hardware 12 and memory hardware 14 storing instructions that when executed on the data processing hardware 12 cause the data processing hardware 12 to perform operations. The vehicle 10 further includes a sensor system 16 configured to capture/receive sensor data 20. The sensor system 16 may include one or more of cameras, radio detection and ranging (RADAR), and light detection and ranging (LIDAR) capable of capturing image data. While the sensor system 16 shown in FIG. 1 is disposed on a front side of the vehicle, it should be appreciated that the sensor system 16 may include sensors located throughout the vehicle. For example, the sensor system 16 may provide 360 degree surround sensing of an environment of the vehicle 10.

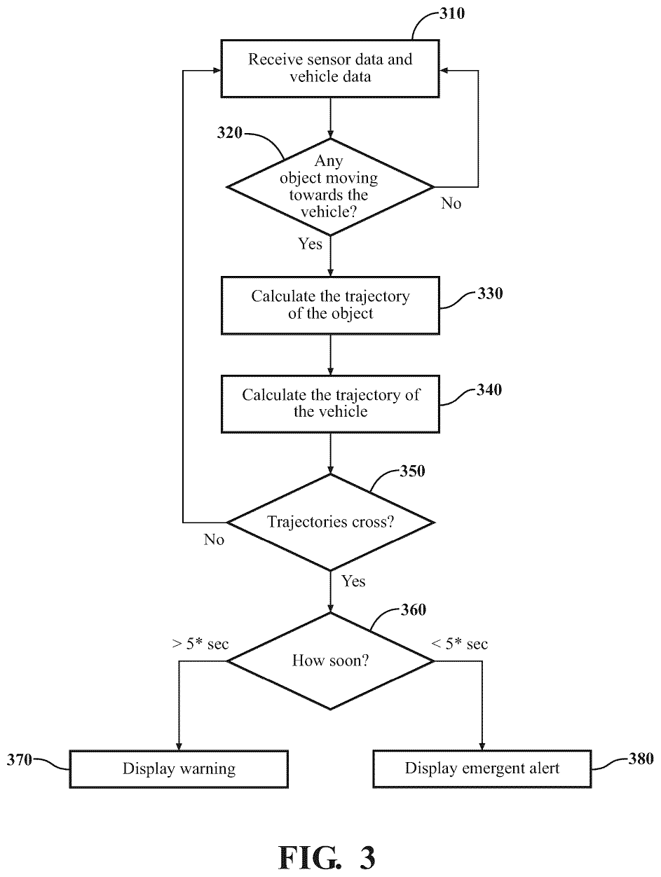

The remote system 60 (e.g., server, cloud computing environment) also includes data processing hardware 62 and memory hardware 64 storing instructions that when executed on the data processing hardware 62 cause the data processing hardware 62 to perform operations. In some examples, execution of the crash warning system 200 is shared across the vehicle 10 and the remote system 60. As described in greater detail below with reference to FIGS. 2 and 3, the crash warning system 200 executing on the vehicle 10 and/or the remote system 60 executes a crash model 300 that is configured to receive the sensor data 20 detected by the sensor system 16 and generate the graphical alert 202 when the sensor data 22 indicates that the vehicle 10 is at imminent risk of a crash with the object 30 and that the object 30 is outside of the line of sight 104 of the driver 102 of the vehicle 10.

As shown in FIGS. 1 and 2, the vehicle 10 further includes a windshield 18 providing pillar-to-pillar display capabilities for the crash warning system 200. In particular, the windshield 18 includes a clear portion 24 and a blackout portion 26. The clear portion 24 may generally refer to the portion of the windshield 18 through which the driver 102 perceives areas outside the vehicle 10. The blackout portion 26 may generally refer to an opaque or blacked out area of the windshield 18 where an instrument cluster and/or infotainment device may be displayed using one or more of, for example, a vacuum fluorescent display (VFP), a light emitting diode (LED) display, a driver information center display, a radio display, an arbitrary text device, a head-up display (HUD), a touchscreen display, a liquid crystal display (LCD), etc.

Referring to FIGS. 1-3, while the vehicle 10 is moving, the vehicle 10 executes the crash warning model 300 that receives, as input, the sensor data 20 detected by the sensor system 16 of the vehicle 10. The sensor data 20 may include one or more data fragments or image data detected by the sensor system 16 and may indicate that an object 30 is moving toward the vehicle 10. For example, the object 30 may include another vehicle that is outside the line of sight 104 of the driver 102 of the vehicle 10. However, the object 30 may include any object capable of causing a collision with the vehicle 10 such as, without limitation, motorcycles, trucks, sports utility vehicles (SUVs), recreational vehicles (RVs), off-road vehicles, etc. The crash warning system 200 may additionally receive vehicle data 22 including a direction of the vehicle 10, a velocity of the vehicle 10, and/or a current location of the vehicle 10. The crash warning model 300 then determines whether there is an imminent risk of a crash between the vehicle 10 and the object 30 and generates, for output to the head-up displays 204, the graphical alert 202.

Referring to FIG. 3, the crash warning model 300 is shown. Here, as the vehicle 10 is moving, the crash warning model 300 continuously receives/processes the sensor data 20 from the sensor system 16 and the vehicle data 22 to determine whether to output the graphical alert 202 to the head-up displays 204. At operation 310, the crash warning model 300 receives the sensor data 20 detected by the sensor system 16 of the vehicle 10 and the vehicle data 22 of the vehicle 10. The crash warning model 300 then determines, at operation 320, whether any objects 30 are detected that are moving toward the vehicle 10. For example, the crash warning model 300 may determine whether any sensor data 20 includes objects 30 approaching the vehicle 10 based on a location of the vehicle 10 and a location of the objects 30. When the crash warning model 300 determines that an object 30 is moving toward the vehicle 10, the operations further include, at operation 330, calculating a trajectory of the object 30. Here, the trajectory of the object 30 may refer to a position, a direction and/or a velocity of the object 30 based on the current sensor data 20 and/or recently received sensor data 20.

At operation 340, the crash warning model 300 calculates a trajectory of the vehicle 10. For example, the crash warning model 300 may determine, based on the vehicle data 22, a position, a direction, and/or a velocity of the vehicle 10, where the trajectory of the vehicle 10 may refer to the position, direction, and/or velocity of the vehicle 10. In some implementations, the vehicle data 22 is measured/reported by an inertial measurement unit (IMU). After calculating the trajectory of the object 30 and the trajectory of the vehicle 10, the crash warning model 300 determines, at operation 350, whether the trajectory of the object 30 and the trajectory of the vehicle 10 cross. In other words, the crash warning model 300 determines, based on the respective trajectories of the object 30 and the vehicle 10, whether a collision between the object 30 and the vehicle 10 is about to occur. Here, the crash warning model 300 may compare the position, direction, and/or velocity of the object 30 to the position, direction, and/or velocity of the vehicle 10, and when the trajectories indicate that the object 30 and the vehicle 10 will collide, proceed to operation 360.

At operation 360, the crash warning model 300 determines how soon the trajectory of the object 30 and the trajectory of the vehicle 10 will cross. In particular, the crash warning model 300 determines, based on the trajectory of the object 30 and the trajectory of the vehicle 10, a time to collision between the object 30 and the vehicle 10. In these implementations, the graphical alert 202 may be generated based on the time to collision between the object 30 and the vehicle 10. In other words, the graphical alert 202 may be configured based on the urgency indicated by the time to collision between the object 30 and the vehicle 10. In particular, the size, prominence, colors, and/or flashing of the graphical alert 202 may change based on the urgency indicated by the time to collision of the object 30 and the vehicle 10. For example, when the time to collision between the object 30 and the vehicle 10 is longer (e.g., greater than five (5) seconds), and therefore less urgent, the crash warning model 300 may generate/display, at operation 370, a graphical alert 202 that warns the driver 102 about the object 30 outside of the line of sight 104 of the driver 102. Here, the graphical alert 202 that warns the driver 102 may use smaller graphics, colors and/or flashing elements to indicate that the imminent object 30 is less urgent. Alternatively, when the time to collision between the object 30 and the vehicle 10 is shorter (e.g., less than five (5) seconds), and therefore urgent, the crash warning model 300 may generate/display, at operation 380, a graphical alert 202 that warns the driver 102 about the imminent object 30 outside of the line of sight 104 of the driver 102. Here, the graphical alert 202 that warns the driver 102 may use larger graphics, brighter/bolder colors and/or flashing elements to indicate that the imminent object 30 is urgent and likely to result in a collision.

Referring again to FIG. 2, after the crash warning model 300 determines that the object 30 and the vehicle 10 are on trajectories that will cross, the crash warning system 200 generates the graphical alert 202. In particular, the crash warning system 200 outputs the graphical alert 202 to the head-up displays 204. As shown, the head-up displays 204 include an augmented reality head-up display 206 and a blackout head-up display 208, where the augmented reality head-up display 206 is configured to project images onto the clear portion 24 of the windshield 18 and the blackout head-up display is configured to project images onto the blackout portion 26 of the windshield 18. The graphical alert 202 may generally include an augmented reality image overlay 210 and a virtual image 212 that are each projected by the respective components of the head-up displays 204. For example, the augmented reality head-up display 206 may receive the graphical alert 202 including the augmented reality image overlay 210 and project the augmented reality image overlay 210 onto the clear portion 24 of the windshield in a location on the windshield 18 within the line of sight 104 of the driver 102. In some implementations, the augmented reality image overlay 210 indicates a direction that the object 30 that is outside of the line of sight 104 of the driver 102 is moving. Similarly, the blackout head-up display 208 may be configured to display images on the blackout portion 26 of the windshield 18. In particular, the blackout head-up display 208 may receive the graphical alert 202 including the virtual image 212 and project the virtual image 212 onto the blackout portion 26 of the windshield 18. In some implementations, the augmented reality image overlay 210 and the virtual image 212 are projected onto the windshield 18 simultaneously.

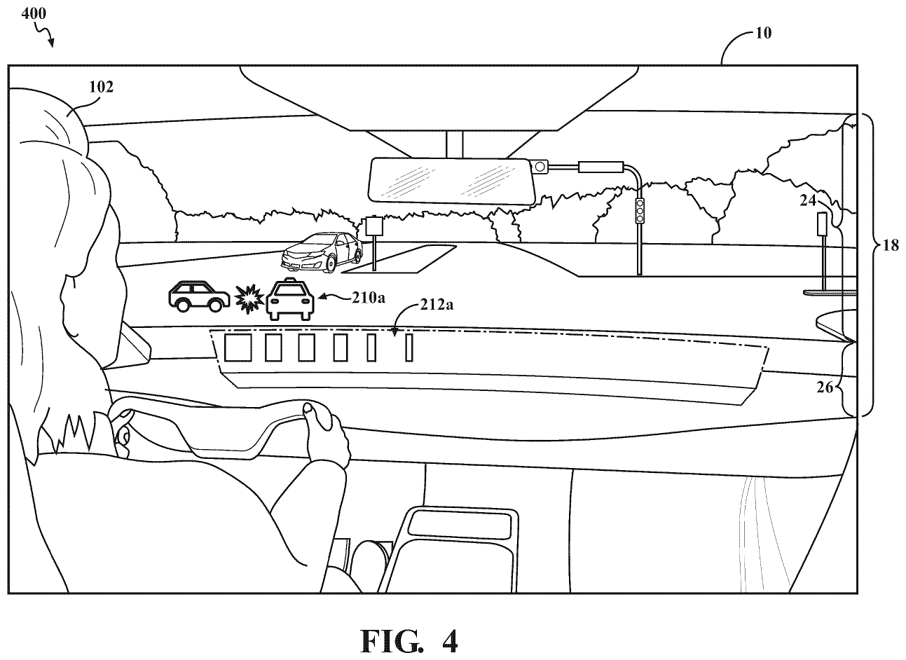

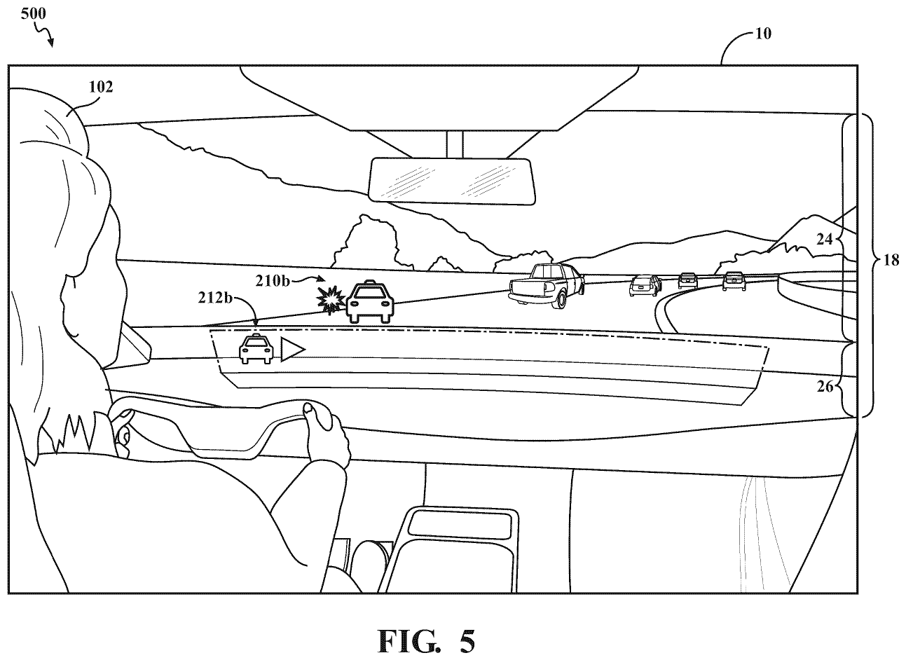

Referring to FIGS. 4 and 5, example components 400a, 400b are shown and include the vehicle 10 executing the crash warning system 200 to warn the driver 102 that an object 30 outside of the line of sight 104 of the driver 102 is at risk of imminent collision with the vehicle 10. By warning the driver 102 (i.e., via the graphical alert 202), the driver 102 is given additional time to react/avoid the collision. It should be appreciated that the graphical alert 202 projected onto the windshield 18 may be configured/modified base on the urgency of the time to collision between the object 30 and the vehicle 10. For example, the graphical alert 202 may employ images in varying sizes, colors, and or other alert techniques to capture the attention of the driver 102 without pulling the attention of the driver 102 from the road. In some implementations, the augmented reality image overlay 210 is different from the virtual image 212.

With reference to FIG. 4, the crash warning system 200 may detect, based on the sensor data 20, that an object 30 (e.g., another vehicle (not shown)) to the left of the vehicle 10 is likely to hit the vehicle 10. For example, the object 30 may be on a trajectory of running a red light such that it will hit the vehicle 10 in the intersection. Here, the object 30 is outside of the line of sight 104 of the driver 102 such that the driver 102 is unable to see the object 30. In response to detecting the object 30 and that it is likely to collide with the vehicle 10, the crash warning system 200 generates the graphical alert 202 including the augmented reality image overlay 210a and the virtual image 212a. As shown, the augmented reality image overlay 210a is projected onto the clear portion 24 of the windshield 18 in a location on the windshield 18 within the line of sight 104 of the driver 102 such that the augmented reality image overlay 210a appears to be positioned on the road in front of the vehicle 10. Here, the augmented reality image overlay 210a includes an image of two vehicles with a crash symbol to alert the driver 102 to the potential collision. Simultaneously, the virtual image 212a is projected onto the blackout portion 26 of the windshield 18 on the left side of the windshield 18 to indicate that the object is on the left of the vehicle 10.

With reference to FIG. 5, the crash warning system 200 may detect, based on the sensor data 20, that an object 30 (e.g., another vehicle (FIG. 1)) to the left of the vehicle 10 is likely to hit the vehicle 10. For example, the object 30 may be on a trajectory of trying to pass the vehicle 10 in an unsafe manner that will likely result in sideswiping the vehicle 10. Here, the object 30 is outside of the line of sight 104 of the driver 102 such that the driver 102 is unable to see the object 30. In response to detecting the object 30 and that it is likely to collide with the vehicle 10, the crash warning system 200 generates the graphical alert 202 including the augmented reality image overlay 210b and the virtual image 212b. As shown, the augmented reality image overlay 210b is projected onto the clear portion 24 of the windshield 18 in a location on the windshield within the line of sight 104 of the driver 102 such that the augmented reality image overlay 210a appears to be positioned on the road in front of the vehicle 10. Here, the augmented reality image overlay 210a includes an image of a vehicle on the left side of the windshield 18 with a crash symbol to alert the driver 102 to the potential collision. Simultaneously, the virtual image 212b is projected onto the blackout portion 26 of the windshield 18 on the left side of the windshield 18 and includes an image of a vehicle including an arrow pointing to the right to alert the driver 102 that the trajectory of the object 30 is to the right towards the vehicle 10.

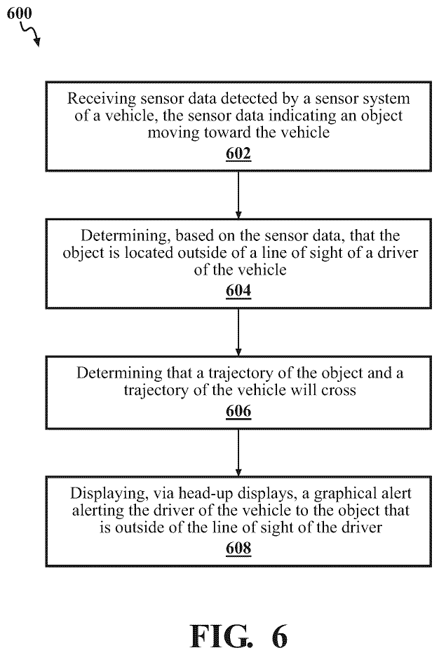

FIG. 6 includes a flowchart of an example arrangement of operations for a method 600 of non-line-of-sight imminent crash warning using reflective head-up displays. The method 600 may be described with reference to FIGS. 1-5. Data processing hardware (e.g., data processing hardware 12, 62 of FIG. 1) may execute instructions stored on memory hardware (e.g., memory hardware 14, 64 of FIG. 1) to perform the example arrangement of operations for the method 600.

At operation 602, the method 600 includes receiving sensor data 20 detected by a sensor system 16 of a vehicle 10. The sensor data 20 may indicate that an object 30 is moving toward the vehicle 10. The method 600 also includes, at operation 604, determining, based on the sensor data 20, that the object 30 is located outside of a line of sight 104 of a driver 102 of the vehicle 10. At operation 606, the method 600 further includes, determining that a trajectory of the object 30 and a trajectory of the vehicle 10 will cross. The method 600 also includes, at operation 608, displaying, via head-up displays 204, a graphical alert 202 alerting the driver 102 of the vehicle 10 to the object 30 that is outside of the line of sight 104 of the driver 102.

A number of implementations have been described. Nevertheless, it will be understood that various modifications may be made without departing from the spirit and scope of the disclosure. Accordingly, other implementations are within the scope of the following claims.

The foregoing description has been provided for purposes of illustration and description. It is not intended to be exhaustive or to limit the disclosure. Individual elements or features of a particular configuration are generally not limited to that particular configuration, but, where applicable, are interchangeable and can be used in a selected configuration, even if not specifically shown or described. The same may also be varied in many ways. Such variations are not to be regarded as a departure from the disclosure, and all such modifications are intended to be included within the scope of the disclosure.

What is claimed is:

1. A computer-implemented method when executed on data processing hardware causes the data processing hardware to perform operations comprising:
receiving sensor data detected by a sensor system of a vehicle, the sensor data indicating an object moving toward the vehicle;
determining, based on the sensor data, that the object is located outside of a line of sight of a driver of the vehicle;
determining that a trajectory of the object and a trajectory of the vehicle will cross; and
displaying, via head-up displays, a graphical alert alerting the driver of the vehicle to the object that is located outside of the line of sight of the driver.

2. The method of claim 1, wherein the head-up displays include an augmented reality head-up display and a blackout head-up display.

3. The method of claim 2, wherein displaying, via the head-up displays, a graphical alert alerting the driver of the vehicle to the object that is located outside of the line of sight of the driver comprises:
generating an augmented reality image overlay;
generating a virtual image; and
projecting the augmented reality image overlay and the virtual image on a windshield of the vehicle simultaneously.

4. The method of claim 3, wherein projecting the augmented reality image overlay and the virtual image on the windshield of the vehicle comprises projecting the augmented reality image overlay on a clear portion of the windshield and projecting the virtual image on a blackout portion of the windshield.

5. The method of claim 3, wherein the augmented reality image overlay is different from the virtual image.

6. The method of claim 1, wherein the sensor system comprises one or more of:
cameras;
radio detection and ranging (RADAR); and
light detection and ranging (LIDAR).

7. The method of claim 1, wherein determining that a trajectory of the object and a trajectory of the vehicle will cross comprises:
receiving vehicle data;
calculating, based on the sensor data, the trajectory of the object;
calculating, based on the vehicle data, the trajectory of the vehicle; and
determining whether the trajectory of the object and the trajectory of the vehicle cross.

8. The method of claim 7, wherein the operations further comprise determining, based on the trajectory of the object and the trajectory of the vehicle, a time to collision between the object and the vehicle.

9. The method of claim 8, wherein the operations further comprise generating the graphical alert based on the time to collision between the object and the vehicle.

10. The method of claim 1, wherein displaying, via the head-up displays, the graphical alert alerting the driver of the vehicle to the object that is located outside of the line of sight of the driver comprises displaying the graphical alert on a windshield of the vehicle to indicate a direction of the object.

11. A system comprising:
data processing hardware; and
memory hardware in communication with the data processing hardware, the memory hardware storing instructions that when executed on the data processing hardware cause the data processing hardware to perform operations comprising:
receiving sensor data detected by a sensor system of a vehicle, the sensor data indicating an object moving toward the vehicle;
determining, based on the sensor data, that the object is located outside of a line of sight of a driver of the vehicle;
determining that a trajectory of the object and a trajectory of the vehicle will cross; and
displaying, via head-up displays, a graphical alert alerting the driver of the vehicle to the object that is located outside of the line of sight of the driver.

12. The system of claim 11, wherein the head-up displays include an augmented reality head-up display and a blackout head-up display.

13. The system of claim 12, wherein displaying, via the head-up displays, a graphical alert alerting the driver of the vehicle to the object that is located outside of the line of sight of the driver comprises:
generating an augmented reality image overlay;
generating a virtual image; and
projecting the augmented reality image overlay and the virtual image on a windshield of the vehicle simultaneously.

14. The system of claim 13, wherein projecting the augmented reality image overlay and the virtual image on the windshield of the vehicle comprises projecting the augmented reality image overlay on a clear portion of the windshield and projecting the virtual image on a blackout portion of the windshield.

15. The system of claim 13, wherein the augmented reality image overlay is different from the virtual image.

16. The system of claim 11, wherein the sensor system comprises one or more of:
cameras;
radio detection and ranging (RADAR); and
light detection and ranging (LIDAR).

17. The system of claim 11, wherein determining that a trajectory of the object and a trajectory of the vehicle will cross comprises:
receiving vehicle data;
calculating, based on the sensor data, the trajectory of the object;
calculating, based on the vehicle data, the trajectory of the vehicle; and
determining whether the trajectory of the object and the trajectory of the vehicle cross.

18. The system of claim 17, wherein the operations further comprise determining, based on the trajectory of the object and the trajectory of the vehicle, a time to collision between the object and the vehicle.

19. The system of claim 18, wherein the operations further comprise generating the graphical alert based on the time to collision between the object and the vehicle.

20. The system of claim 11, wherein displaying, via the head-up displays, the graphical alert alerting the driver of the vehicle to the object that is located outside of the line of sight of the driver comprises displaying the graphical alert on a windshield of the vehicle to indicate a direction of the object.
